(19) United States
(12) Patent Application Publication
(10) Pub. No.: US 2025/0319526 A1
(43) Pub. Date: Oct. 16, 2025

(54) RAM CLAMPING SYSTEM

(71) Applicant: ADELBERT HAAS GMBH, Trossingen (DE)

(72) Inventor: Timo ZEPF, Seitingen-Oberflacht (DE)

(21) Appl. No.: 19/097,515

(22) Filed: Apr. 1, 2025

(30) Foreign Application Priority Data
Apr. 12, 2024 (DE) 102024110353.1

(51) Int. Cl. B23B 31/20

(52) U.S. Cl. CPC B23B 31/20

(57) ABSTRACT

Provided is ram clamping system (100) comprising a rotationally symmetrical main body (110), which has an opening that passes through the rotationally symmetrical main body (110) along its axis of symmetry, in which opening a drawbar (140) extends, comprising a collet (120) which can be clamped by means of the drawbar (140) for fixing a ram (190) associated with the ram clamping system (100), and comprising an exchangeable holder (180), through the interior (181) of which the ram (190) passes before entering the collet (120), wherein at least one portion of the collet (120) projects in the direction of extension of the drawbar (140) beyond the end face of the main body (110), on which end face the exchangeable holder (180) is arranged, and enters the interior (181) of the exchangeable holder (180).

Machine tools are becoming increasingly automated. This means, in particular, that tool changes during operation of such a machine tool are also carried out partially or fully automatically. It is common practice to connect the various tools to a spindle, a pivot pin or other subassembly of the machine tool via a tool holder.

There are also cases where the workpiece to be machined is coupled to the spindle, the pivot pin or other subassembly of the machine tool. To clarify this, the term “tool or workpiece holder” is used below, although in principle any tool holder is also a workpiece holder or becomes a workpiece holder when the clamping means, in which the tool is intended to be held in the case of a tool holder, is used to hold a workpiece.

It is known to fasten tools or workpieces, which have an axial hole, in the tool or workpiece holder by means of a clamping ram which, in particular, has an elongate cylindrical shaft with a collar which, in particular, forms a radial bulge at one end. For this purpose, the clamping ram is guided through the hole, and the cylindrical shaft of the clamping ram is gripped in a chuck, which is usually arranged inside a main body of the ram clamping system, and is retracted axially to such an extent that the tool or workpiece rests against a contact surface of a holder—in many cases a tool—or workpiece-specific holder that is therefore usually exchangeably arranged on the end face of the ram clamping system—and is held clamped between the contact surface and the collar of the clamping ram.

A problem with known ram clamping systems is that their holding torque suffers from the high torsion of the ram due to the considerable length of the ram. The object of the invention is therefore to provide a ram clamping system which has an improved holding torque. This object is achieved by a ram clamping system having the features of claim 1. The dependent claims relate to advantageous developments of the invention.

The ram clamping system according to the invention has a rotationally symmetrical main body, which has an opening passing through the rotationally symmetrical main body along its axis of symmetry, in which opening a drawbar extends. In addition, said ram clamping system has a collet, which can be clamped by means of the drawbar for fixing a ram associated with the ram clamping system, and has an exchangeable holder, through the interior of which the ram passes before entering the collet. It should be noted that both the holder and the ram may be adapted to the relevant workpiece geometry and are therefore exchangeable parts. A ram clamping system may therefore also include a plurality of holders and/or a plurality of rams, of which, however, only one holder and one ram each are used for operation.

It is essential to the invention that at least one portion of the collet projects in the direction of extension of the drawbar beyond the end face of the main body, on which end face the exchangeable holder is arranged, and enters the interior of the exchangeable holder. In this way, it is possible to use significantly shorter rams than has until now usually been the case, the torsion of which is lower due to their shorter length, making it possible to work with higher holding torques.

In a particularly preferred embodiment of the invention, the clamping arms of the collet have, located axially behind the clamping jaws, a recess in which an ejector for the ram is accommodated. Said ejector may be in the form of a mandrel located in the front region of the drawbar and allows rams, with the head countersunk in the tool or workpiece during machining with the tool or during machining of the workpiece, to be pushed out of the countersink when the collet is released to change the tool or workpiece, so that they can be gripped more easily by an operator or a robot.

While, in principle, an interaction of the clamping jaws of the collet with the wall surfaces of the opening passing through the main body can be used when the clamping jaws are pulled into the opening, so that said clamping jaws cause the collet receptacle to produce the desired clamping effect of the clamping jaws on the ram, in a preferred embodiment of the invention the ram clamping system has a collet receptacle which projects beyond the end face of the main body, on which end face the exchangeable holder is arranged, in the direction of extension of the drawbar and enters the interior of the exchangeable holder. If clamping jaws of the collet that taper in the pulling direction are pulled into the collet receptacle, a clamping effect of the inner sides of the clamping jaws inward with the ram and a clamping effect of the outer sides of the clamping jaws with the collet receptacle is achieved, which clamping effect is advantageous in terms of the positioning accuracy that can be achieved.

It is particularly advantageous for achieving said clamping effect if the walls of the collet receptacle have slots or groove-shaped weakened regions.

It has a particularly advantageous effect on the achievable positioning accuracy if the collet receptacle is clamped within the main body in the axial direction by a spiral spring and is clamped in the direction of expansion by a disk spring.

The ram clamping system can be operated particularly easily by means of a machine tool if the drawbar has, at its end opposite the collet, a pull stud or drawbar adapter for connection to a spindle clamping system of a machine tool.

Additionally, in a preferred embodiment of the invention, the collet is releasably connected to the drawbar and arranged on the main body such that the collet can be removed from the main body in the direction opposite to the direction of insertion of the ram into the collet after the connection to the drawbar has been released. This makes it possible to easily replace the collet if it is worn or defective, and to use collets with different diameters, so that, for example, it is possible to increase the ram clamping/pulling diameter for workpieces with a larger bore where high machining forces are applied, thereby pulling with greater force and clamping the workpiece more tightly.

This can be achieved very easily, for example, by connecting the collet to the drawbar via a screw connection. An alternative option is to connect the collet to the drawbar via a bayonet connection.

To facilitate the insertion and removal of the collet, it is helpful if the clamping jaws of the collet have, on their end face facing away from the drawbar, openings for receiving a tool for releasing the connection between the collet and the drawbar and/or for pulling the collet out of the main body. Such a tool may also be a separate part of the ram clamping system.

The invention is explained in more detail below with reference to drawings showing exemplary embodiments. In the drawings:

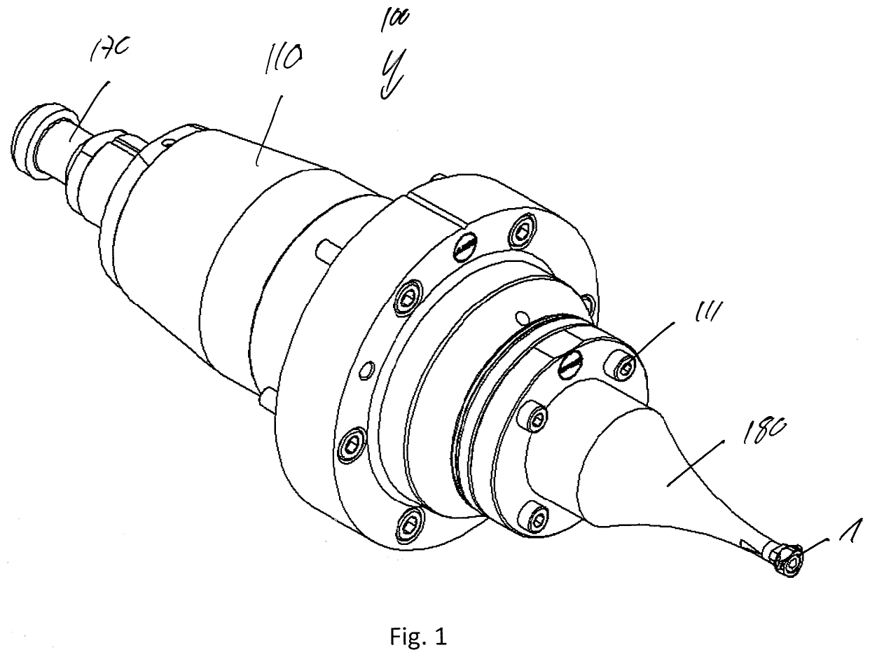

FIG. 1: shows an isometric illustration of a ram clamping system with clamped workpiece;

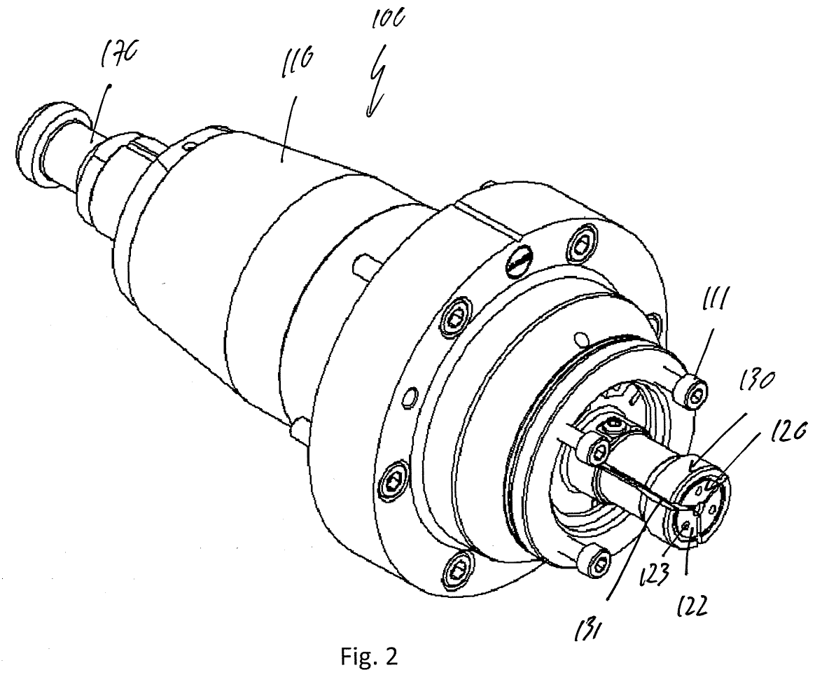

FIG. 2: shows an isometric illustration of the ram clamping system from FIG. 1 with the ram and holder removed;

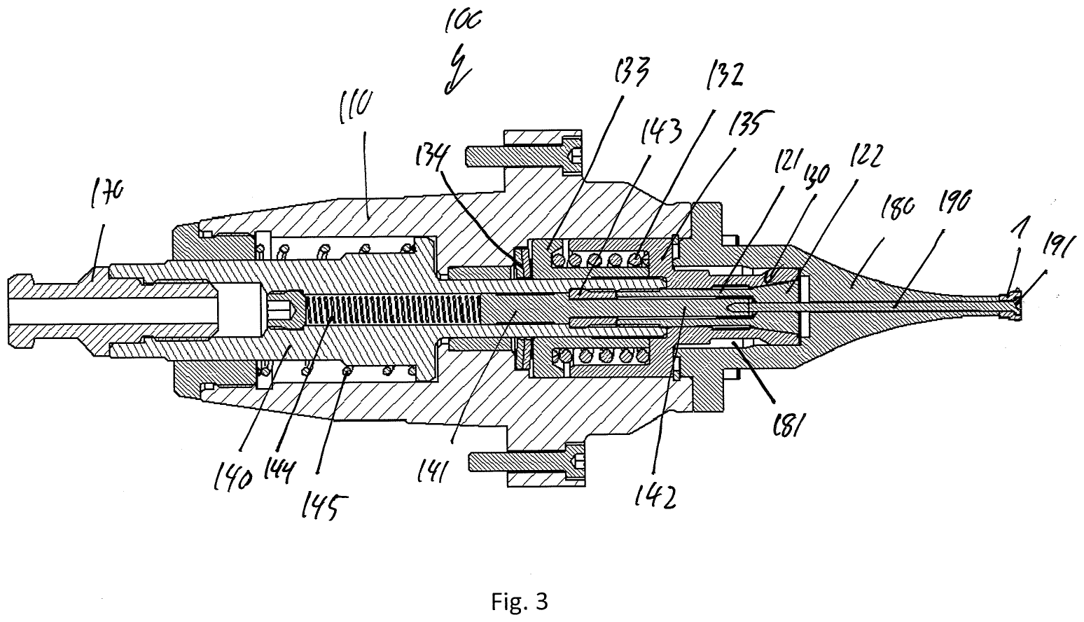

FIG. 3: shows a sectional view of the ram clamping system with clamped workpiece from FIG. 1; and

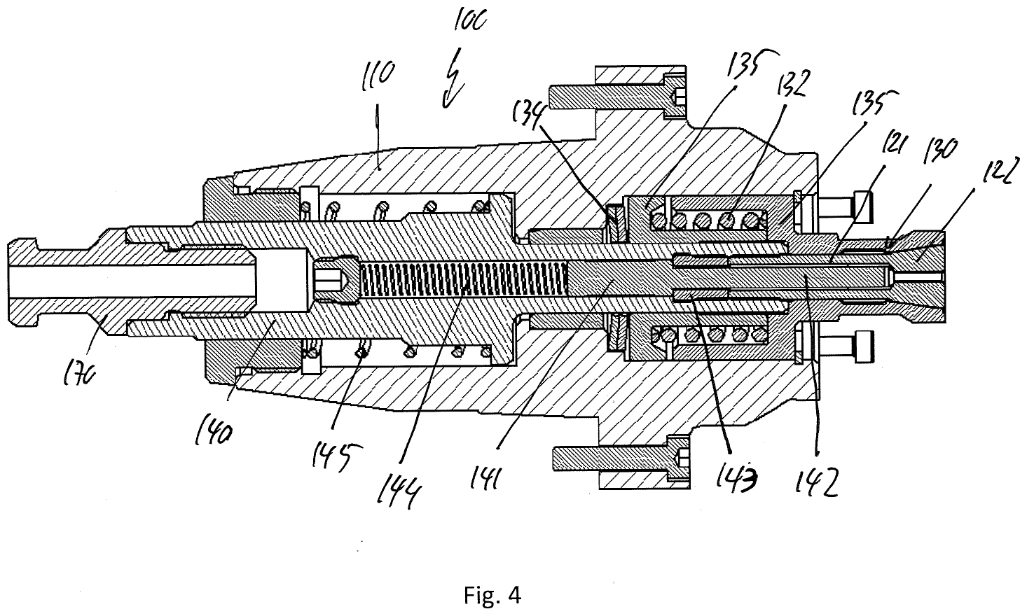

FIG. 4: shows a sectional view of the ram clamping system with the ram and holder from FIG. 2 removed.

FIG. 1 shows an isometric illustration of a ram clamping system 100 with clamped workpiece 1. The main body 110 of the ram clamping system can be seen, on the end face of which, facing the viewer, a workpiece-specific holder 180 is arranged—in the present example with four screws 111, but other alternatives such as a quick-change system are also possible. At the end of the holder that faces the viewer, a contact surface for the workpiece 1 is arranged, which in FIG. 1 is concealed by the workpiece 1 resting thereon, said workpiece 1 being fixed by a ram 190, which passes through an opening in the workpiece 1 in such a way that its ram head 191 is countersunk in the workpiece 1, to the contact surface of the holder 180 formed by the end face of the holder 180 that faces the workpiece 1.

At the end of the main body that faces away from the viewer, a pull stud or drawbar adapter 170 can be seen, via which the ram clamping system 100 is actuated by a machine tool on which it is installed. The function of the ram clamping system 100 during such an actuation is explained in detail below.

In the illustration according to FIG. 2, the ram clamping system 100 is shown with the holder 180 removed, so that it is possible to see the collet 120 projecting beyond the end face of the main body 110 and the collet receptacle 130 of said collet, which also projects beyond the end face of the main body 110 and has slots 131 in this exemplary embodiment. Accordingly, when the holder 180 is installed, the collet 120 and the collet receptacle 130 are accommodated at least partially in the interior 181 of the holder 180, which is visible in FIG. 4; however, at least in the exemplary embodiment shown, they each also have portions that are arranged in the main body 110, as shown in FIGS. 3 and 4.

In FIG. 2, it can also be clearly seen that the clamping jaws 122 arranged at the end of the clamping arms 121 of the collet 120 that faces the workpiece 1 have, on their end face facing away from the drawbar 140, which is hidden by the main body 110 in the illustration in FIG. 2 but visible in FIGS. 3 and 4, openings 123 for receiving a tool for releasing the connection between the collet 120 and the drawbar 140 and/or for pulling the collet 120 out of or pushing it into the main body 110.

Further details on the design of the ram clamping system 100 and its mode of operation can be found in the sectional illustrations shown in FIGS. 3 and 4. In this illustration, one can see the opening 112 which passes through the main body 110 along its axis of symmetry, which coincides with the central axis of the rotationally symmetrical main body 110, around which the rotation takes place when the ram clamping system 100 is used.

A drawbar 140 is arranged inside the opening 112 and is connected at its end opposite the collet 120 to the pull stud or drawbar adapter 170, via which the ram clamping system 100 is actuated by a machine tool on which it is installed. Starting from the other end of the drawbar 140, a concentric bore leads into the interior of the drawbar 140, the end of which has, on the side facing the workpiece 1, a means for releasably connecting to the collet 120. In the example shown, this is an internal thread into which the collet 120 is screwed with an external thread arranged at the end of the clamping arms 121 opposite the clamping jaws 122.

In the interior of this bore, an ejector 141 having an extension 142 is also arranged so as to be axially displaceable, although the displacement in the direction of the workpiece 1 is limited by a stop 143 which is fixedly connected to the drawbar 140. The extension 142 engages with recesses which are provided in the clamping arms 121 of the collet 120 in the axial direction behind the clamping jaws 122. The ejector 141 is supported at its base opposite the workpiece 1 by a spring 144.

As can be seen particularly clearly in FIG. 3, a portion of the clamping arms 121 is accommodated within the main body 110 of the ram clamping system 100, while another portion of the clamping arms 121 (and thus of the collet 120) including the clamping jaws 122 projects beyond the end face of the main body 110 facing the workpiece 1 and, as FIG. 4 shows, is accommodated in the interior 181 of the holder 180.

Also projecting into the interior 181 of the holder 180 is the collet receptacle 130, the portion 135 of which that extends within the main body 110 is supported by a spiral spring 132 on a base piece 133, which in turn is mounted on a disk spring 134, thereby causing the collet receptacle 130 to be clamped within the main body 110 in the axial direction by the spiral spring 132 and to be clamped in the direction of expansion by the disk spring 134 upon actuation of the drawbar 140.

In order to clamp a workpiece 1 or tool with the ram clamping system 100, it is threaded onto the ram 190, the ram head 191 of which can establish a form fit with the workpiece or tool, and the end of the ram 190 opposite the ram head 191 is inserted between the clamping jaws 122 of the collet 120, so that the workpiece 1 comes to rest against the contact surface formed by the end face of the holder 180 facing the workpiece.

By pulling on the pull stud or drawbar adapter 170, the drawbar 140 is then retracted against the resistance of the compression spring 145, which at the same time causes the clamping arms 121 of the collet 120 to be retracted. This results in a clamping effect of the collet 120 on the ram 190 due to the interaction of the clamping jaws 122, whose outer diameter increases in the direction toward the workpiece 1, while the inner diameter of the collet receptacle 130 decreases in the opposite direction. Accordingly, the ram 190 is gripped and pulled toward the end of the main body 110, as a result of which the ejector 142 is pushed back against the force of the spring 144 and the workpiece 1 is pulled against the contact surface. In particular, due to the slots 131 or weakened regions of the collet receptacle 130 and their mounting or clamping by the spiral spring 132 and the disk spring 134, a high degree of positioning accuracy is maintained.

If the tension on the drawbar 140 is no longer maintained, the compression spring 145 pushes the drawbar 140 forward again. Accordingly, the collet 120 slides forward in the collet receptacle 130, the ram 190 ceases being clamped by the clamping jaws 122 and the spring 144 can relax, with the result that the ram 190 is ejected and is now easy to grasp.

### LIST OF REFERENCE SIGNS

1 Workpiece
100 Ram clamping system
110 Main body
111 Screw
120 Collet
121 Clamping arm
122 Clamping jaw
123 Opening
130 Collet receptacle
131 Slot
132 Spiral spring
133 Base piece
134 Disk spring
135 Portion
140 Drawbar
141 Ejector
142 Extension
143 Stop
144 Spring
145 Compression spring
170 Pull stud or drawbar adapter
180 Holder
181 Interior
190 Ram
191 Ram head

1. A ram clamping system (100) comprising a rotationally symmetrical main body (110), which has an opening that passes through the rotationally symmetrical main body (110) along its axis of symmetry, in which opening a drawbar (140) extends, having a collet (120) which can be clamped by means of the drawbar (140) for fixing a ram (190) associated with the ram clamping system (100), and having an exchangeable holder (180), through the interior (181) of which the ram (190) passes before entering the collet (120), characterized in that
at least one portion of the collet (120) projects in the direction of extension of the drawbar (140) beyond the end face of the main body (110), on which end face the exchangeable holder (180) is arranged, and enters the interior (181) of the exchangeable holder (180).

2. The ram clamping system (100) according to claim 1,
characterized in that the clamping arms (121) of the collet (120) have, located axially behind the clamping jaws (122), a recess in which an ejector (141) for the ram (190) is accommodated.

3. The ram clamping system (100) according to claim 1, characterized in that the ram clamping system (100) has a collet receptacle (130) which projects beyond the end face of the main body (110), on which end face the exchangeable holder (180) is arranged, in the direction of extension of the drawbar (140) and enters the interior (181) of the exchangeable holder (180).

4. The ram clamping system (100) according to claim 3,
characterized in that the walls of the collet receptacle (130) have slots (130) or groove-shaped weakened regions.

5. The ram clamping system (100) according to claim 3, characterized in that the collet receptacle (130) is clamped within the main body (110) in the axial direction by a spiral spring (132) and is clamped in the direction of expansion by a disk spring (134).

6. The ram clamping system (100) according to claim 1, characterized in that the drawbar (140) has, at its end opposite the collet (120), a pull stud or drawbar adapter (170) for connection to a spindle clamping system of a machine tool.

7. The ram clamping system (100) according to claim 1, characterized in that the collet (120) is releasably connected to the drawbar (140) and arranged on the main body (110) such that the collet (120) can be removed from the main body (110) in the direction opposite to the direction of insertion of the ram (190) into the collet (120) after the connection to the drawbar (140) has been released.

8. The ram clamping system (100) according to claim 7,
characterized in that the collet (120) is connected to the drawbar (140) via a screw connection.

9. The ram clamping system (100) according to claim 7,
characterized in that the collet (120) is connected to the drawbar (140) via a bayonet connection.

10. The ram clamping system (100) according to claim 7, characterized in that the clamping jaws (122) of the collet (120) have, on their end face facing away from the drawbar (140), openings (123) for receiving a tool for releasing the connection between the collet (120) and the drawbar (140) and/or for pulling the collet (120) out of the main body (110).
